(19) United States
(12) Patent Application Publication
(10) Pub. No.: US 2025/0343247 A1
(43) Pub. Date: Nov. 6, 2025

(54) FLOW-ASSISTED BATTERY

(71) Applicant: The Regents of the University of California, Oakland, CA (US)

(72) Inventors: Daniel Collins-Wildman, Oakland, CA (US); Kenneth Higa, Berkeley, CA (US); Vincent Battaglia, San Anselmo, CA (US)

(21) Appl. No.: 18/864,646

(22) PCT Filed: May 17, 2023
(86) PCT No.: PCT/US2023/022517

§ 371 Date: Nov. 12, 2024

Related U.S. Application Data
(60) Provisional application No. 63/343,332, filed on May 18, 2022.

(51) Int. Cl. H01M 4/86; H01M 8/0239; H01M 8/04186; H01M 8/18

(52) U.S. Cl. CPC H01M 4/86; H01M 8/0239; H01M 8/04186; H01M 8/188

(57) ABSTRACT

Described herein are systems, methods, and apparatus related to flow-assisted batteries. In one aspect, a battery includes an electrode, a cathode, and an electrolyte. The electrode comprises an electrically conductive material and serves as a surface onto which anode material is deposited when the battery is in operation. The cathode comprises a plurality of sheets of cathode material.

### RELATED APPLICATIONS

This application claims priority to U.S. Provisional Patent Application No. 63/343,332, filed May 18, 2022, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

In order to combat climate change by switching from fossil fuels to renewable sources of energy generation, there is a need for the development of new energy storage technologies. A robust network of energy storage facilities is essential for the stability of a grid fueled primarily by wind and solar power. Given the scale of the need for energy storage, it is necessary for the storage technology to be low-cost, safe, and recyclable at the end of its life.

### SUMMARY

Described herein is a flow-assisted battery. In some embodiments, an aqueous (and non-flammable) electrolyte (e.g., an electrolyte solution) and earth-abundant materials are used to keep the projected chemical, manufacturing, and operation costs relatively low and to reduce safety concerns. The flow-through electrode design further reduces the projected manufacturing and operation costs and simplifies material recovery/recycling. While some embodiments described herein use an aqueous electrolyte, a flow-assisted battery can be used with a non-aqueous electrolyte as well.

Compared with other flow-assisted batteries, the design offers competitive cost projections and higher energy density by using solid-state electrochemically active materials. As energy storage facilities become larger and larger, these savings from low up-front costs and efficient recycling will become increasingly important for keeping the cost of renewable energy storage affordable.

One innovative aspect of the subject matter described in this disclosure can be implemented in a battery including an electrode, a cathode, and an electrolyte. The battery comprises an electrically conductive material and serves as a surface onto which anode material is deposited when the battery is in operation. The cathode comprises a plurality of sheets of cathode material.

In some embodiments, the electrically conductive material comprises a metal. In some embodiments, spacers are disposed between adjacent sheets of the plurality of sheets of cathode material.

In some embodiments, the electrode comprises a plurality of sheets of electrode material, and sheets of the plurality of sheets of electrode material are in electrical contact with one another. In some embodiments, electrode spacers are disposed between adjacent sheets of the plurality of sheets of electrode material.

In some embodiments, sheets of the plurality of sheets of cathode material are in electrical contact with one another.

In some embodiments, the electrode comprises cadmium. In some embodiments, the electrode comprises cadmium-plated nickel or cadmium-plated steel.

In some embodiments, each sheet of the plurality of sheets of cathode material is about 0.1 millimeters to 1 millimeter thick. In some embodiments, dimensions of each sheet of the plurality of sheets of cathode material are about 0.2 centimeters to 1.5 centimeters by about 0.5 centimeters to 5 meters. In some embodiments, the plurality of sheets of cathode material has a stacked thickness of about 0.5 centimeters to 5 meters substantially perpendicular to a flow direction of the electrolyte when the battery is in operation.

In some embodiments, the plurality of sheets cathode material are positioned substantially parallel to a flow direction of the electrolyte when the battery is in operation.

In some embodiments, adjacent sheets of the plurality of sheets of cathode material are positioned about 0.25 millimeters to 0.75 millimeters from each other. In some embodiments, a number of the plurality of sheets of cathode material is at least about 4 sheets.

In some embodiments, the battery does not include a separator positioned between the electrode and the cathode. In some embodiments, the battery further comprises a separator positioned between the electrode and the cathode.

In some embodiments, when the battery is in operation, the electrolyte flows through the plurality of sheets of cathode material prior to flowing past the electrode.

In some embodiments, a spacing between the electrode and the cathode is about 1.5 millimeters to 4.5 millimeters substantially parallel to a flow direction of the electrolyte when the battery is in operation.

In some embodiments, each sheet of the plurality of sheets of cathode material comprises a sheet of nickel with a Ni(OH)₂ paste disposed thereon, the anode material comprises zinc, and the electrolyte comprises zinc oxide or zinc hydroxide. In some embodiments, the electrolyte further comprises KOH and K₂Zn(OH)₄.

In some embodiments, the spacers comprise polypropylene. In some embodiments, the spacers comprise a polypropylene mesh. In some embodiments, the spacers are each about 0.25 millimeters to 0.75 millimeters thick.

In some embodiments, the battery further comprises a pump. The pump is operable to flow the electrolyte through the plurality of sheets of cathode material and past the electrode when the battery is in operation.

In some embodiments, the battery is a flow-assisted battery.

In some embodiments, each of plurality of sheets of cathode material comprises a substrate having particles of the cathode material disposed thereon. In some embodiments, each of plurality of sheets of cathode material comprises a container having particles of the cathode material disposed therein.

Another innovative aspect of the subject matter described in this disclosure can be implemented in a battery including an electrolyte, an anode, and a cathode. The anode comprises a porous material through which the electrolyte can flow when the battery is in operation and includes an embedded continuous electronic conductor phase.

Another innovative aspect of the subject matter described in this disclosure can be implemented in a battery including an electrolyte, a cathode, and an anode. The cathode comprises a porous material through which the electrolyte can flow when the battery is in operation and includes an embedded continuous electronic conductor phase.

Another innovative aspect of the subject matter described in this disclosure can be implemented in a battery including a cathode, an anode, and an electrolyte. The cathode comprises a plurality of sheets of cathode material with cathode spacers being disposed between adjacent sheets of the plurality of sheets of cathode. Sheets of the plurality of sheets of cathode material are in electrical contact with one another. The anode comprises a plurality of sheets of anode material with anode spacers being disposed between adjacent sheets of the plurality of sheets of anode material. Sheets of the plurality of sheets of anode material are in electrical contact with one another.

Another innovative aspect of the subject matter described in this disclosure can be implemented in a method including providing a battery, the battery comprising an electrode, the electrode comprising a first metal, the electrode serving as a surface onto which anode material is deposited when the battery is in operation, the anode material comprising a second metal, a cathode, and an electrolyte, with the battery having been operated and the anode material being disposed on the electrode. The anode material disposed on the electrode is exposed to air. The anode material disposed on the electrode is exposed to the electrolyte. The exposing operations serve to dissolve the anode material disposed on the electrode into the electrolyte.

Another innovative aspect of the subject matter described in this disclosure can be implemented in a method including providing a battery, the battery comprising an electrode, the electrode comprising a metal, the electrode serving as a surface onto which anode material is deposited when the battery is in operation, the anode material being zinc, a cathode, and an electrolyte, with the battery having been operated and zinc being disposed on the electrode. The zinc disposed on the electrode is exposed to air. The zinc disposed on the electrode is exposed to the electrolyte. The exposing operations serve to dissolve the zinc disposed on the electrode into the electrolyte.

In some embodiments, the cathode comprises nickel with nickel oxide disposed thereon.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a schematic illustration of an arrangement of interlaced electrodes of a flow-assisted battery.

FIG. 2 shows an example of a schematic illustration of a flow-assisted battery.

FIG. 3 shows an example of a flow diagram illustrating a process for removing zinc from an electrode of a flow-assisted battery.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Described herein is a design for a flow-assisted battery including a flow-through electrode and a flow cell that can be used with a variety of different chemistries. In particular, this design has been applied to improve the performance of nickel-zinc flow-assisted batteries. Alternative cathode chemistries, such as manganese dioxide, can also be used. The flow-through electrode design improves the achievable energy density for nickel-zinc flow-assisted batteries, lowers the manufacturing precision needed, and simplifies the material recovery at end of life. All of these factors will help in lowering the overall cost.

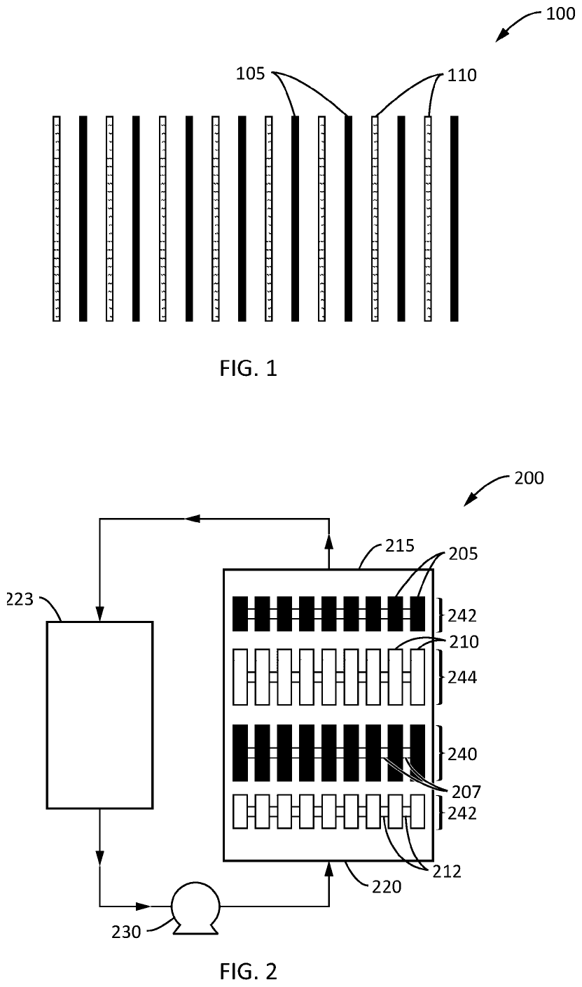

Previously, nickel-zinc flow-assisted batteries involved the flow of electrolyte (e.g., an electrolyte solution) between interlaced zinc anode and nickel cathode plates. FIG. 1 shows an example of a schematic illustration of an arrangement of interlaced electrodes of a flow-assisted battery. As shown in FIG. 1, electrodes 100 of a flow-assisted battery include anode plates 105 (i.e., anode plates extending into the page) that are interlaced with cathode plates 110 (i.e., anode plates extending into the page). In some embodiments, the anode plates 105 comprise a zinc anode. In some embodiments, the cathode plates 110 comprise a nickel cathode. In some embodiments, the cathode plates 110 are either sintered or pocket-type nickel hydroxide plates that are common in the field. In some embodiments, the anode plates 105 comprise a metal substrate on which the zinc is plated/stripped during charge/discharge processes. In some embodiments, the electrolyte flow direction was parallel to the electrode plates.

In flow-assisted batteries including interlaced electrodes as shown in FIG. 1, the zinc tends to plate non-uniformly on the anode surface, creating features known as dendrites that could bridge the gap between the anode plates 105 and cathode plates 110. Flowing the K₂Zn(OH)₄ electrolyte helps mitigate dendrite formation, but does not eliminate it completely. In order to avoid short-circuiting the cell through dendrite growth, the electrodes are positioned at a spacing greater than some minimum distance, which limited the energy density that can be achieved in the battery. Spacing between electrode plates also needs to be maintained to prevent the electrodes from accidentally touching.

Embodiments described herein address the above-described limitations by enabling anode and/or cathode assemblies of greater thickness than the individual electrode plates. Normally, the electrode thickness is limited by ion transport through the pores of the electrode. The embodiments described herein make use of through-flow of electrolyte as well as embedded continuous (e.g., length scale greater than 10 microns) electronic conductor phases to enable thick electrode assemblies. With thick electrode assemblies, the overall energy density of the battery is increased without requiring a decrease in the spacing between anodes and cathodes.

In some embodiments, flow channels are introduced by taking pocket-type electrodes of a certain width and stacking them together with thin mesh spacers in between. The width of each individual electrode added together then becomes the thickness of the overall anode or cathode assembly. The anode and cathode assemblies are separated along the direction of fluid flow. Fluid flow is used to mitigate electrolyte concentration gradients, in addition to suppressing dendrite growth. This design is an important development as thick electrodes without the presence of flow-through channels may fail due to prohibitively large electrolyte resistances.

FIG. 2 shows an example of a schematic illustration of a flow-assisted battery. As shown in FIG. 2, a battery 200 includes a battery housing 215 and an electrolyte reservoir 223. The battery housing 215 and the electrolyte reservoir 223 are in fluid communication. The battery housing 215 contains an electrode 205 and a cathode 210.

The electrode 205 comprises an electrically conductive material and serves as a surface onto which anode material is deposited when the battery 200 is in operation. In some embodiments, the electrode 205 comprises a metal. The cathode 210 comprises a plurality of sheets of cathode material. In some embodiments, sheets of the plurality of sheets of cathode material are in electrical contact with one another. In some embodiments, spacers 212 are disposed between adjacent sheets of the plurality of sheets of cathode material. In some embodiments, each sheet of the plurality of sheets of cathode material comprises a metal. The battery 200 also includes an electrolyte 220. In some embodiments, the electrolyte 220 is an aqueous electrolyte. In some embodiments, the electrolyte 220 is a non-aqueous electrolyte. In some embodiments, the battery 200 is a flow-assisted battery.

In some embodiments, the battery 200 includes a pump 230. The battery housing 215, the electrolyte reservoir 223, and the pump 230 are in fluid communication. The pump 230 is operable to flow the electrolyte through the plurality of sheets of cathode material and past the electrode when the battery is in operation 200.

In some embodiments, each sheet of the plurality of sheets of cathode material is about 0.1 millimeters to 1 millimeter thick. In some embodiments, dimensions of each sheet of the plurality of sheets of cathode material are about 0.2 centimeters to 1.5 centimeters, or about 1 centimeter, by about 0.5 centimeters to 5 meters.

In some embodiments, the plurality of sheets of cathode material has a stacked thickness of about 0.5 centimeters to 5 meters substantially perpendicular to a flow direction of the electrolyte when the battery is in operation. That is, a thickness of the plurality of sheets of cathode material and the spacers disposed between adjacent sheets of cathode material is about 0.5 centimeters to 5 meters. In some embodiments, the plurality of sheets cathode material are positioned substantially parallel to a flow direction of the electrolyte when the battery is in operation. That is, the sides of a sheet of the cathode material with the largest area is positioned substantially parallel to a flow direction of the electrolyte when the battery is in operation.

In some embodiments, adjacent sheets of the plurality of sheets of cathode material are positioned about 0.25 millimeters to 0.75 millimeters, or about 0.5 millimeters, from each other. The positioning allows for the electrolyte to flow between adjacent sheets of the cathode material when battery 200 is in operation. In some embodiments, a number of the plurality of sheets of cathode material is at least about 4 sheets.

In some embodiments, the electrode 205 comprises a plurality of sheets of electrode material. In some embodiments, electrode spacers 207 are disposed between adjacent sheets of the plurality of sheets of electrode material. In some embodiments, each sheet of the plurality of sheets of material of electrode material comprises a metal. In some embodiments, sheets of the plurality of sheets of electrode material are in electrical contact with one another.

In some embodiments, each sheet of the plurality of sheets of electrode material is about 0.1 millimeters to 1 millimeter thick. In some embodiments, dimensions of each sheet of the plurality of sheets of electrode material are about 0.2 centimeters to 1.5 centimeters, or about 1 centimeter, by about 0.5 centimeters or 5 meters.

In some embodiments, the plurality of sheets of electrode material has a stacked thickness of about 0.5 centimeters to 5 meters substantially perpendicular to a flow direction of the electrolyte when the battery is in operation. That is, a thickness of the plurality of sheets of electrode material and the electrode spacers disposed between adjacent sheets of cathode material is about 0.5 centimeters to 5 meters. In some embodiments, the plurality of sheets of electrode material are positioned substantially parallel to a flow direction of the electrolyte when the battery is in operation. That is, the sides of a sheet of the electrode material with the largest area is positioned substantially parallel to a flow direction of the electrolyte when the battery is in operation.

In some embodiments, adjacent sheets of the plurality of sheets of electrode material are positioned about 0.25 millimeters to 0.75 millimeters, or about 0.5 millimeters, from each other. The positioning allows for the electrolyte to flow between adjacent sheets of the electrode material when battery 200 is in operation. In some embodiments, a number of the plurality of sheets of electrode material is at least about 4 sheets.

In some embodiments, when the electrode 205 comprises a plurality of sheets of electrode material, sheets of the cathode material and sheets of the electrode material are not interlaced as described with respect to FIG. 1. In some embodiments, the plurality of sheets of cathode material form a stack of sheets of cathode material. In some embodiments, the plurality of sheets of electrode material form a stack of sheets of electrode material. In some embodiments, when the battery 200 is in operation, the electrolyte 220 flows through the stack of sheets of cathode material and then through the sheets of electrode material. In some embodiments, when the battery 200 is in operation, the electrolyte 220 flows through the stack of sheets of electrode material and then through the sheets of cathode material (e.g., an opposite direction of flow of the electrolyte through the battery housing from what is shown in FIG. 2).

As shown in FIG. 2, in some embodiments, the battery 200 includes one or more stacks of the cathode material (242 and 244) and one or more stacks of the electrode material (246 and 248). In some embodiments, the stacks of the cathode material (242 and 244) the stacks of the electrode material (246 and 248) are alternating, i.e., a first stack of cathode material 242, a first stack electrode material 264, a second stack of cathode material 244, and a second stack of electrode material 248. In some embodiments, when the battery 200 is in operation the electrolyte flows through the first stack of cathode material 242, then the first stack electrode material 264, then the second stack of cathode material 244, and finally the second stack of electrode material 248. In some embodiments, when the battery 200 is in operation, the electrolyte flows in the opposite direction.

In some embodiments, the electrode comprises cadmium. In some embodiments, the electrode comprises cadmium-plated nickel or cadmium-plated steel.

In some embodiments, the battery 200 further includes a separator (not shown) positioned between the electrode 205 and the cathode 210. In some embodiments, the separator comprises a non-conductive material. In some embodiments, the separator comprises a polymer membrane or a glass fiber woven mesh or screen.

A separator aids in preventing contact between the electrode 205 and the cathode 210 while allowing for ion transport between the anode and the cathode, through the separator. In some embodiments, the battery does not include a separator positioned between the electrode 205 and the cathode 210.

In some embodiments, when the battery 200 is in operation, the electrolyte flows through the plurality of sheets of cathode material prior to flowing past the electrode. That is, the electrode is downstream from the plurality of sheets of cathode material. In some embodiments, when the battery 200 is in operation, the electrolyte flows past the electrode prior to flowing past the plurality of sheets of cathode material. That is, the plurality of sheets of cathode material is downstream from the electrode. In some embodiments, a spacing between the electrode and the cathode is about 1.5 millimeters to 4.5 millimeters, or about 3 millimeters, substantially parallel to a flow direction of the electrolyte when the battery is in operation.

In some embodiments, the spacers and the electrode spacers comprise polypropylene, nylon, acrylonitrile butadiene-styrene copolymer (ABS), polytetrafluroethylene (PTFE), acrylic, or a polyolefin (e.g., an acrylic polymer). In some embodiments, the spacers and the electrode spacers comprise polypropylene. In some embodiments, the spacers and the electrode spacers comprise a polypropylene mesh. In some embodiments, the spacers and the electrode spacers are each about 0.25 millimeters to 0.75 millimeters thick.

In some embodiments, each sheet of the plurality of sheets of cathode material comprises a sheet of nickel with a Ni(OH)₂ paste disposed thereon. In some embodiments, the anode material comprises zinc. In some embodiments, the electrolyte comprises zinc oxide or zinc hydroxide. In some embodiments, the electrolyte further comprises KOH and K₂Zn(OH)₄.

In some embodiments, the battery 200 includes an anode comprising an anode material instead of an electrode 205 onto which an anode material is deposited. For example, in some embodiments, a battery includes a cathode, the cathode comprising a plurality of sheets of cathode material, cathode spacers being disposed between adjacent sheets of the plurality of sheets of cathode material, sheets of the plurality of sheets of cathode material being in electrical contact with one another, an anode, the anode comprising a plurality of sheets of anode material, anode spacers being disposed between adjacent sheets of the plurality of sheets of anode material, sheets of the plurality of sheets of anode material being in electrical contact with one another, and an electrolyte.

In some embodiments, each of the plurality of sheets of cathode material comprises a porous composite cathode. In some embodiments, a porous composite cathode comprises particles of the cathode material, with the particles of the cathode material defining pore space. That is, the particles of the cathode material are arranged such that the electrolyte can flow past individual particles of the cathode material or groups of individual particles of the cathode material when the battery is in operation.

In some embodiments, the particles of the cathode material are bonded together with a binder material. In some embodiments, the binder material comprises polyvinylidene fluoride, polytetrafluoroethylene, polyvinyl acetate, polylactic acid, or styrene-butadiene rubber.

In some embodiments, a porous composite cathode comprises a substrate having the particles of the cathode material disposed thereon. In some embodiments, the substrate comprises a metal (e.g., nickel, aluminum, or copper).

In some embodiments, a porous composite cathode comprises a container within which the particles of the cathode material are disposed. The container is porous to allow electrolyte to flow into and out of the container. The container can be viewed as an envelope holding the particles of the cathode material. In some embodiments, the container comprises a metal (e.g., nickel, aluminum, or copper).

In some embodiments, a porous composite cathode further comprises an electrically conductive material mixed with the particles of cathode material. In some embodiments, the electrically conductive material comprises carbon fibers, carbon nanotubes, carbon black, or powder of a metal (e.g., nickel, aluminum, or copper), or strands of a metal (e.g., nickel, aluminum, or copper).

In some embodiments, each of the plurality of sheets of electrode (anode) material comprises a porous composite electrode (anode). In some embodiments, a porous composite electrode (anode) comprises particles of the electrode (anode) material, with the particles of the electrode (anode) material defining pore space. That is, the particles of the electrode (anode) material are arranged such that the electrolyte can flow past individual particles of the electrode (anode) material or groups of individual particles of the electrode (anode) material when the battery is in operation.

In some embodiments, the particles of the electrode (anode) material of bonded together with a binder material. In some embodiments, the binder material comprises polyvinylidene fluoride, polytetrafluoroethylene, polyvinyl acetate, polylactic acid, or styrene-butadiene rubber.

In some embodiments, a porous composite electrode (anode) comprises a substrate having the particles of the electrode (anode) material disposed thereon. In some embodiments, the substrate comprises a metal (e.g., nickel, aluminum, or copper).

In some embodiments, a porous composite electrode (anode) comprises a container within which the particles of the electrode (anode) material are disposed. The container is porous to allow electrolyte to flow into and out of the container. The container can be viewed as an envelope holding the particles of the electrode (anode) material. In some embodiments, the container comprises a metal (e.g., nickel, aluminum, or copper).

In some embodiments, a porous composite electrode (anode) further comprises an electrically conductive material mixed with the particles of electrode (anode) material. In some embodiments, the electrically conductive material comprises carbon fibers, carbon nanotubes, carbon black, or powder of a metal (e.g., nickel, aluminum, or copper), or strands of a metal (e.g., nickel, aluminum, or copper).

In some embodiments, a battery includes an electrolyte, an anode, and a cathode. The anode comprises a porous material through which the electrolyte can flow when the battery is in operation. The anode further includes an embedded continuous electronic conductor phase. In some embodiments, the embedded continuous electronic conductor phase comprises a nickel mesh, carbon fibers, or other conductive additive. In some embodiments, the embedded continuous electronic conductor phase has a length scale greater than about 10 microns.

In some embodiments, a battery includes an electrolyte, a cathode, and an anode. The cathode comprises a porous material through which the electrolyte can flow when the battery is in operation. The cathode further includes an embedded continuous electronic conductor phase. In some embodiments, the embedded continuous electronic conductor phase comprises a nickel mesh, carbon fibers, or other conductive additive. In some embodiments, the embedded continuous electronic conductor phase has a length scale greater than about 10 microns.

Some embodiments of the battery 200 described above implement a nickel-zinc battery chemistry. The embodiments described herein can also be used to implement batteries of other battery chemistries, including (cathode material/anode material pairs (in the discharged state)):
alkaline battery chemistries including Ni(OH)₂/Cd(OH)₂ (KOH electrolyte), Ni(OH)₂/hydrogen storage alloy (KOH electrolyte), and MnO₂/K₂Zn(OH)₄ (KOH and K₂Zn(OH)₄electrolyte); and
lithium/sodium ion chemistries including lithium manganese oxide/lithium titanium phosphate (lithium bis(trifluoromethanesulfonyl)imide electrolyte) and sodium manganese oxide/sodium titanium phosphate (sodium perchlorate electrolyte).

When in operation, a nickel-zinc flow battery including electrodes arranged in any of the configurations described herein (e.g., FIG. 1 or FIG. 2), zinc in plated on the electrode (i.e., the anode). In the case of the electrode configuration shown in FIG. 1, zinc dendrites can grow on an electrode plate and contact a cathode, creating a short circuit in the battery. In the case of the electrode configuration shown in FIG. 2, uneven plating of zinc on an electrode plate may occur, impairing flow of the electrolyte in the flow-assisted battery. Or, excess zinc may be plated on an electrode plate. Excess zinc disposed on an electrode plate can be re-dissolved into the electrolyte by exposing the zinc to the electrolyte and then to air. These exposures to the electrolyte and to air can be repeated.

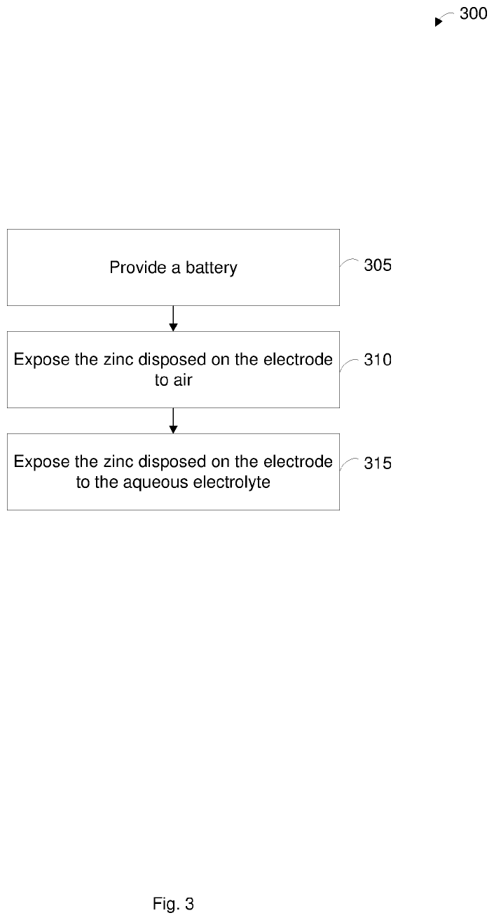

FIG. 3 shows an example of a flow diagram illustrating a process for removing zinc from an electrode of a flow-assisted battery. At block 305 of the process 300, a battery is provided. The battery includes an electrode, a cathode, and an electrolyte. The electrode comprises a metal and serves a surface onto which anode material is deposited when the battery is in operation. The anode material is zinc. In some embodiments, the cathode comprises nickel with nickel oxide disposed thereon. The battery has been operated and zinc is deposited on the electrode.

At block 310, the zinc disposed on the electrode is exposed to air. At block 315, the zinc disposed on the electrode is exposed to the electrolyte. The operations at blocks 310 and 315 serve to dissolve the zinc disposed on the electrode into the electrolyte. The operations at blocks 310 and 315 may be repeated until most of or all of the zinc is removed from the electrode and dissolved in the electrolyte.

The method described with respect to FIG. 3 may also be used with other battery chemistries to remove a metal from an electrode.

The following examples are intended to be examples of the embodiments disclosed herein, and are not intended to be limiting.

### EXAMPLE

In a laboratory implementation of an embodiment, the cathode comprised a series of nickel hydroxide tabs separated by plastic screens which were held with a polyether ether ketone (PEEK) holder that fit snugly into a PVC pipe. Each Ni(OH)₂ tab included the active material paste (Ni(OH)₂:CB:PTFE in a weight ratio of 66:30:4) surrounded by a perforated nickel sheet. The nickel sheet simultaneously acts as the current collector and a means of containing the active material. Each tab was folded and pressed to 24,000 psi before being assembled in the tab holder. The screens between Ni(OH)₂ tabs enable electrolyte to flow past the surface of the tabs while also providing a rigid structure to maintain the shape and position of the tabs in the holder. To electrically connect each tab to the external circuit, sections of perforated nickel that extend up past the active material were folded down on one another and pressed up against a nickel wire that passes through the wall of the PVC pipe. All holes drilled in the PVC pipe were sealed with chemically resistant epoxy.

### Conclusion

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A battery, the battery being a flow assisted battery, comprising:
an electrode, the electrode comprising a plurality of sheets of electrode material, sheets of the plurality of sheets of electrode material being in electrical contact with one another, the electrode material comprising an electrically conductive material, the electrode serving as a surface onto which anode material is deposited when the battery is in operation;
a cathode, the cathode comprising a plurality of sheets of cathode material, sheets of the plurality of sheets of cathode material being in electrical contact with one another; and
an electrolyte.

2. The battery of claim 1, wherein the electrically conductive material comprises a metal.

3. The battery of claim 1, wherein spacers are disposed between adjacent sheets of the plurality of sheets of cathode material.

4. (canceled)

5. The battery of claim 1, wherein electrode spacers are disposed between adjacent sheets of the plurality of sheets of electrode material.

6. (canceled)

7. (canceled)

8. The battery of claim 1, wherein the electrode comprises cadmium-plated nickel or cadmium-plated steel.

9. The battery of claim 1, wherein each sheet of the plurality of sheets of cathode material is about 0.1 millimeters to 1 millimeter thick.

10. The battery of claim 1, wherein dimensions of each sheet of the plurality of sheets of cathode material are about 0.2 centimeters to 1.5 centimeters by about 0.5 centimeters to 5 meters.

11. The battery of claim 1, wherein the plurality of sheets of cathode material has a stacked thickness of about 0.5 centimeters to 5 meters substantially perpendicular to a flow direction of the electrolyte when the battery is in operation.

12. The battery of claim 1, wherein the plurality of sheets cathode material are positioned substantially parallel to a flow direction of the electrolyte when the battery is in operation.

13. The battery of claim 1, wherein adjacent sheets of the plurality of sheets of cathode material are positioned about 0.25 millimeters to 0.75 millimeters from each other.

14. (canceled)

15. The battery of claim 1, wherein the battery does not include a separator positioned between the electrode and the cathode.

16. The battery of claim 1, further comprising:
a separator positioned between the electrode and the cathode.

17. The battery of claim 1, wherein when the battery is in operation, the electrolyte flows through the plurality of sheets of cathode material prior to flowing past the electrode.

18. The battery of claim 1, wherein a spacing between the electrode and the cathode is about 1.5 millimeters to 4.5 millimeters substantially parallel to a flow direction of the electrolyte when the battery is in operation.

19. The battery of claim 1, wherein each sheet of the plurality of sheets of cathode material comprises a sheet of nickel with a Ni(OH)₂ paste disposed thereon, wherein the anode material comprises zinc, and wherein the electrolyte comprises zinc oxide or zinc hydroxide.

20. (canceled)

21. The battery of claim 3, wherein the spacers comprise polypropylene.

22. The battery of claim 3, wherein the spacers comprise a polypropylene mesh.

23. The battery of claim 3, wherein the spacers are each about 0.25 millimeters to 0.75 millimeters thick.

24. The battery of claim 1, further comprising:
a pump, the pump operable to flow the electrolyte through the plurality of sheets of cathode material and past the electrode when the battery is in operation.

25-29. (canceled)

30. A battery comprising:
a cathode, the cathode comprising a plurality of sheets of cathode material, cathode spacers being disposed between adjacent sheets of the plurality of sheets of cathode, sheets of the plurality of sheets of cathode material being in electrical contact with one another;
an anode, the anode comprising a plurality of sheets of anode material, anode spacers being disposed between adjacent sheets of the plurality of sheets of anode material, sheets of the plurality of sheets of anode material being in electrical contact with one another; and
an electrolyte.

31-33. (canceled)
